(19) United States
(12) Patent Application Publication
(10) Pub. No.: US 2004/0030568 A1
(43) Pub. Date: Feb. 12, 2004

(54) Method and system for selling authorizations

(75) Inventors: Wolfram Kocznar, Innsbruck (AT); Thomas Donhauser, Salzburg (AT); Christian Windhager, Elsbethen (AT)

Correspondence Address: HENRY M FEIEREISEN, LLC, 350 FIFTH AVENUE, SUITE 4714, NEW YORK, NY, 10118, US

(73) Assignee: T & M Consulting GmbH,, Salzburg (AT)

(21) Appl. No.: 10/409,667

(22) Filed: Apr. 8, 2003

Related U.S. Application Data
(63) Continuation of application No. PCT/AT01/00324, filed on Oct. 10, 2001.

(30) Foreign Application Priority Data
Oct. 10, 2000 (AT) GM 751/2000

(51) Int. Cl. G06F 17/60

(52) U.S. Cl. 705/1; 705/5

(57) ABSTRACT

In a method and a system for selling authorizations for events or the like, particularly for various types of tickets, sellable authorizations are defined in databases, and an advance booking agency or a purchaser accesses via the Internet the database for reserving and/or purchase of the authorizations. The venues are equipped with admission readers for identifying tickets provided in the form of data carriers, and the admission readers of each venue communicate with an area server, which includes a database of the sold authorizations for this venue. The servers are connected via a network, for example the Internet. The advance booking agencies or private users connect to a Web server by entering suitable addresses. The Web server retrieves the sellable price quotation from the database of the area server over a secure connection, and displays the sellable price quotation on the display of the advance booking office.

### CROSS-REFERENCES TO RELATED APPLICATIONS

This application is a continuation of prior filed copending PCT International application no. PCT/AT01/00324, filed Oct. 10, 2001, on which priority is claimed under 35 U.S.C. §120, the disclosure of which is hereby incorporated by reference.

This application claims the priority of Austrian Patent Application, Serial No. GM 751/2000, filed Oct. 10, 2000, pursuant to 35 U.S.C. 119(a)-(d), the disclosure of which is incorporated herein by reference.

### BACKGROUND OF THE INVENTION

The present invention relates to a a method and system for selling of authorizations for events and the like, in particular for properly authorizing advanced sales of tickets for such events.

Various systems for pre-selling of tickets are known in the art. Such systems most commonly use central servers which store the sellable tickets in a database. When a ticket is sold, an advance booking agency accesses the database of the server via a suitable data link and marks the corresponding ticket as having been sold. The ticket itself is centrally printed and sent to the purchaser.

More recently, systems use the Internet as an inexpensive medium for connecting a server with the advance booking agency. However, even when using the Internet or other electronic communication means, the ticket disadvantageously has to be sent from the central server to the purchaser after the actual purchase. It has been proposed to make the reservation in the database of a central Web server and to transmit corresponding ticket data to the advance booking agency. In this case, the ticket can be printed at the location of the purchaser. However, it is difficult to automatically monitor ticket sales in this way.

It would therefore be desirable and advantageous to provide an improved device for automatically monitoring and tracking ticket sales, which obviates prior art shortcomings and is able to specifically encode a ticket at the advance booking agency by using ticket data transmitted by a decentralized server.

### SUMMARY OF THE INVENTION

According to one aspect of the present invention, in a method and system for selling authorizations for events or the like, in particular various types of tickets, sellable authorizations are defined in databases, and the database for reservations and/or the purchase of authorizations is accessed via the Internet by an advance booking agency or a purchaser. Venues are provided with access readers for recognizing tickets formed as data carriers, wherein the access readers of each venue communicate with an area server which has a database of the sellable authorizations for this venue. Each area server is connected with the Internet functioning as a communication medium, wherein the advance booking agencies or private users can be connected with a Web server by entering suitable addresses. The Web server recalls the sellable price quotation via a secure connection from the database of the area server and displays the sellable price quotation on a display of the advance booking agency.

This method and system of the invention has the advantage that venues can locally administer those access systems where the sellable tickets are actually defined in a database of the area servers. If an advance booking agency or a private user enters the corresponding Internet address of the desired venue, then the Web server connects with the local area server and retrieves current information. Ticket reservation and ticket sales take place essentially directly at the area server, which can obviate the need for servicing a central server which can be expensive.

According to an advantageous embodiment of the invention, the reservation as well as the sale are completed when the area server, after a ticket has been selected on the display of the advance booking agency or the like, generates suitable ticket data, for example an event number and a seat number, and transmits these data via the Internet to the advance booking agency, and when the ticket is encoded at the advance booking agency by using the ticket data transmitted from the area server. The user thereby directly receives the final ticket which authorizes access to the event.

According to another embodiment of the invention, after a ticket has been selected on the display of the advance booking agency or the like, the advance booking agency transmits to the area server a unique ticket number together with the selected authorization. The area server distributes the authorization identification numbers together with the serial number to the access reader, so that a ticket with the unique ticket number, for example in the form of a bar-code, can be recognized directly at the access reader. This embodiment is particularly suited for gaining direct access with chip cards which the user may have already in his/her possession. The number provided on the chip cards can hereby be used as identification number of the sold authorization.

When the Web server is first queried by the advance booking agency, it can transmit to the advance booking agency a box office program which is stored in the local computer of the advance booking agency. This box office program can receive specific sales parameters from an area server when an area server is queried. A different event can produce different box office interfaces. The box office program only becomes functional in cooperation with the area server.

According to yet another embodiment of the invention, a contingent of tickets can be transferred to the box office program, when an area server is queried. The operation can continue in a limited fashion even under certain emergency conditions, since the box office program can still sell tickets on a limited basis if the connection to the Internet is lost or interrupted. After each sale, a data match—between the local box office program and the area server is attempted, wherein the area server, if necessary, replenishes the allocated contingent.

### BRIEF DESCRIPTION OF THE DRAWING

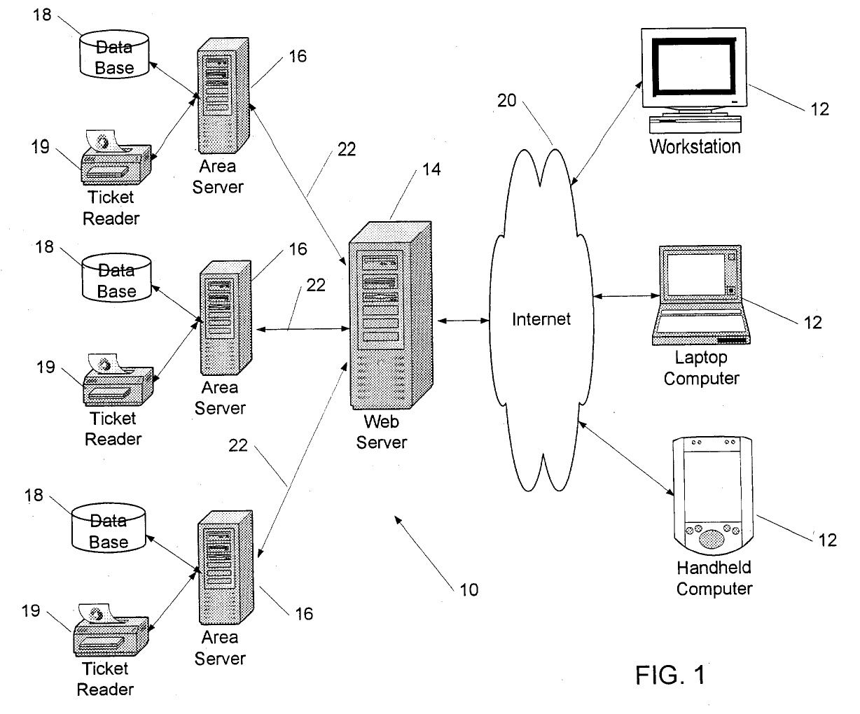

Other features and advantages of the present invention will be more readily apparent upon reading the following description of currently preferred exemplified embodiments of the invention with reference to the accompanying drawing, in which the sole FIG. 1 is a schematic diagram of a system for selling authorizations according to the present invention.

### DETAILED DESCRIPTION OF PREFERRED EMBODIMENTS

The depicted embodiment is to be understood as illustrative of the invention and not as limiting in any way.

Turning now to FIG. 1, there is shown a embodiment of a system 10 according to the invention for selling authorizations, such as the authorizations for tickets described above. Specifically, FIG. 1 illustrates a system 10 wherein a plurality of advance booking agency/private user systems 12 connect through a secure transmission channel 22, such as a dedicated line or an encrypted channel, to a Web server 14. The server 14 connects to one or more area servers 16 via a network, such as the Internet. The area servers 16 include or are connected to ticket databases 18 maintained by the area server 16 and similarly connects, optionally by direct secure lines, to a plurality of access readers 19. The elements of the system 10 can include commercially available systems that have been arranged and modified to act as a system according to the invention, which allows a subscriber to carry out authorization transactions, and optionally generate records of these authorization transactions. The system 10 of FIG. 1 employs the Internet to allow a subscriber at a remote client, the advance booking agency/private user systems 12, to access a central server, the depicted Web server 14, to login to an account maintained by that server, for example, for an area server 16, and to employ the services required to sell or reserve authorizations, for example for tickets to events.

For example, the Web server 14 can present the subscriber with an HTML page that acts as a user interface. This user interface can present to the advance booking agency a set of controls for requesting authorizations and displaying the sellable price quotations on the display of the advance booking agency. For example, the user interface can provide to the booking agency/private user a control, typically a button on a web page, that directs the user to enter ticket data and transmit the ticket data to the Web servers 14.

For the depicted system 10, the client system 12 can be any suitable computer system such as a PC workstation, a handheld computing device, a wireless communication device, or any other such device, equipped with a network client capable of accessing a network server and interacting with the server to exchange information with the server.

The Web server 14 may be supported by a commercially available server platform such as a Sun Sparc™ system running a version of the Unix operating system and running a server capable of connecting with, or exchanging data with, one of the advance booking agency/private user systems 12. In the embodiment of FIG. 1, the server 14 includes a Web server, such as the Apache Web server or any suitable Web server. The Web server component of the server 14 acts to listen for requests from advance booking agency/private user systems 12, and to in response to such a request, resolves the request to identify a filename, script, dynamically generated data that can be associated with that request and to return the identified data to the requesting advance booking agency/private user system 12.

The depicted ticket database 18 may comprise any suitable database, including the commercially available Microsoft Access database, and can be a local or distributed database system. The design and development of database systems suitable for use with the system 10, follow from principles known in the art, including those described in McGovern et al., A Guide To Sybase and SQL Server, Addison-Wesley (1993). The database 18 can be supported by any suitable persistent data memory, such as a hard disk drive, RAID system, tape drive system, floppy diskette, or any other suitable system.

As mentioned above, the Web server 14 and the advance booking agencies/private users can communicate via the Internet 20. Tickets for events, such a theatrical performances and sports events, are sold locally through association with ticket authorizations. The sellable authorizations for the events are defined in databases 18, wherein an advance booking agency or a purchaser 12 accesses via the Internet 20 the Web server 14 to call up suitable addresses on the Web server, with the databases 18 for reserving and/or purchase of the authorizations accessed by Web server 14 via secure lines 22. Each area server 16 is configured to administer tickets for certain venues. Each area server 16 includes at least one database 18 (which need not be a stand-alone database, but may be shared with other area servers 16 or with the Web server 14) which stores sold authorizations for this venue. The Web server 14 then retrieves the sellable price quotations from the database 18 of the area server 16, for example, via the secure connection, and displays the sellable price quotations on the display of the advance booking agency. After a ticket has been selected on the display of the advance booking agency 12 or the private user, ticket data, for example an event number or a seat number, are generated by the area server 16 and transmitted via the Internet 20 to the advance booking agency 12 or the private user, with the ticket being encoded at the advance booking agency or the private user by using ticket data transmitted from the area server 16 to the agency/user 12. The authorized tickets can then be printed by the agency/user 12.

To automate the process further, an area server 16 can be cooperate with an access reader 19, wherein the area server 16 distributes the authorization identification numbers together with the ticket serial number to the access reader 19, so that a ticket with the unique ticket serial number, for example in the form of a bar-code, can be recognized directly by the access reader 19.

According to another embodiment, a user 12 may have in his/her possession a data carrier (not shown), for example, a chip card with a unique data carrier identification number. This unique identification number can be transmitted to the access reader 19 instead of or in addition to the unique ticket serial number, so that the ticket can be read and authorized directly at the access reader 19 based on its data carrier number.

To allow at least temporary offline operation, for example, in the event of a disruption of the network traffic, a contingent of tickets can be transferred to a box office program stored in the local computer of the advance booking agency. The box office program is transmitted to the advance booking agency by the Web server when the Web server is first queried by the advance booking agency. The sales data between the local box office program and the area server can then be matched again after the network connection is reestablished. The area server replenishes the allocated contingent, if necessary.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for selling authorizations for an event, in particular for various types of tickets, comprising the steps of:
defining a sellable authorization in a database connected to an area server associated with a venue of the event, said sellable authorization including a sellable price quotation of a ticket for the event;
a user calling up an address relating to the event on a Web server;
the Web server retrieving a sellable price quotation from the database of the area server via a secure connection and displaying the sellable price quotation to the user;
the user producing a ticket corresponding to a sold authorization; and
an access reader communicating with the area server and receiving from the area server data representing sold authorizations, said access reader recognizing the authorized ticket.

2. The method of claim 1, wherein after the user has selected a ticket, ticket data, such as an event number or a seat number, are generated by the area server and transmitted to the user, and wherein the ticket is encoded at the user by using the transmitted ticket data.

3. The method of claim 1, wherein after the user has selected a ticket, the user transmits a unique ticket number together with the selected authorization to the area server, and wherein the area server transmits the selected authorization and the unique ticket number to the access reader, allowing a ticket with the unique ticket number to be recognized by the access reader.

4. The method of claim 1, wherein the user has associated therewith a unique data carrier number, and wherein after the user has selected a ticket, the user transmits the authorization identification together with the unique data carrier number to the area server, with the access reader receiving from the area server the authorization identification, so that the ticket can be read and authorized directly at the access based on the unique data carrier number.

5. The method of claim 1, wherein the Web server, when first queried by the user, transmits to the user a box office program which is stored in a local memory at the user, and wherein the box office program receives sales criteria from the area server when the area server is queried.

6. The method of claim 5, wherein when an area server is queried, a quantity of tickets is transferred to the box office program, and wherein data between the local box office program and the area server are matched for each sale, with the area server optionally replenishing an insufficient quantity of tickets.

7. The method of claim 3, wherein the unique ticket number is implemented as a barcode.

8. The method of claim 1, wherein the user comprises an advance booking agency.

9. The method of claim 1, wherein the Web server retrieves the sellable price quotation from the database via a secure connection.

10. A system for selling authorizations for an event, in particular for various types of tickets, comprising:
a Web server connected to a network;
a client server connected to the Web server via the network and receiving input from and displaying contents to a user;
an area server connected to the Web server via a secure connection and associated with a venue of the event,
a database connected to the area server and comprising sellable authorizations and sellable price quotations of a ticket for the event; and
an access reader communicating with the area server and receiving from the area server data representing sold authorizations, said access reader adapted to recognize the authorized ticket,
wherein the Web server, based on input from the user, retrieves a sellable price quotation from the database of the area server and displays the sellable price quotation to the user.

11. The system of claim 10, wherein after the user has selected a ticket based on the sellable price quotation, ticket data, such as an event number or a seat number, are generated by the area server and transmitted to the user, and wherein the ticket is encoded at the user by using the transmitted ticket data.

12. The system of claim 10, wherein after the user has selected a ticket based on the sellable price quotation, the client server transmits a unique ticket number together with the selected authorization to the area server, and wherein the area server transmits the selected authorization and the unique ticket number to the access reader, allowing a ticket with the unique ticket number to be recognized by the access reader.

13. The system of claim 10, wherein after the user has selected a ticket based on the sellable price quotation, a unique data carrier number is associated with the user, and the client server transmits the authorization identification together with the unique data carrier number to the area server, with the access reader receiving from the area server the authorization identification, so that the ticket can be read and authorized directly at the access based on the unique data carrier number.

14. The system of claim 10, wherein the Web server, when first queried by the user, transmits to the user a box office program which is stored in a local memory at the user, and wherein the box office program receives sales criteria from the area server when the area server is queried.

15. The system of claim 14, wherein when an area server is queried, a quantity of tickets is transferred to the box office program, and wherein data between the local box office program and the area server are matched for each sale, with the area server optionally replenishing an insufficient quantity of tickets.

16. The system of claim 12, wherein the unique ticket number is implemented in form of a barcode.

17. The method of claim 10, wherein the user comprises an advance booking agency or a private user.

18. A computer system for selling authorizations for events or the like, in particular various types of the tickets, comprising
one or more regional servers being connected to the Internet and having databases defining the sellable authorizations,
one or more admission readers located at a venue of an event for identifying tickets provided in the form of data carriers, the admission readers of each venue communicating with a regional server associated with the venue, with the database of the regional server including sold authorizations for the venue, and
a Web server in communication via the Internet with one or more advance booking agencies or a private user,
wherein an advance booking agency or private user calls up a suitable address on the Web server, which Web server retrieves a sellable price quotation from the database of the regional server via a secure connection and displays the sellable price quotation on a display of the advance booking agency or private user.

19. The system of claim 18, wherein the data carrier comprises a unique ticket identification number represented on the ticket in form of a barcode.

20. The system of claim 18, wherein the data carrier comprises a unique identification number of a user of the ticket.
